(19) United States
(12) Patent Application Publication
(10) Pub. No.: US 2012/0263313 A1
(43) Pub. Date: Oct. 18, 2012

(54) METHOD AND DEVICE OF IMPLEMENTING COMPATIBILITY WITH WIRED EARPHONES

(75) Inventors: Chengdong Yu, Shenzhen (CN); Konggang Wei, Shenzhen (CN); Hailong Liu, Shenzhen (CN); Tongbang Zhang, Nanjing (CN)

(73) Assignee: Huawei Device Co., Ltd., Shenzhen (CN)

(21) Appl. No.: 13/538,494

(22) Filed: Jun. 29, 2012

Related U.S. Application Data
(63) Continuation of application No. PCT/CN2010/079846, filed on Dec. 16, 2010.

(30) Foreign Application Priority Data
Dec. 30, 2009 (CN) 200910249586.4

(51) Int. Cl. H04R 1/10

(52) U.S. Cl. 381/74

(57) ABSTRACT

Embodiments of the present invention provide a method and device of implementing compatibility with wired earphones. The method includes: judging the type of an earphone plug; and controlling, according to the type of the earphone plug, a circuit switch to conduct a circuit path corresponding to the type of the earphone plug. With the method and device provided by the embodiments of the present invention, a terminal device is compatible with earphones of two different standards.

This application is a continuation of International Application No. PCT/CN2010/079846, filed on Dec. 16, 2010, which claims priority to Chinese Patent Application No. 200910249586.4, filed on Dec. 30, 2009, both of which are hereby incorporated by reference in their entireties.

### FIELD OF THE INVENTION

The present invention relates to earphone jacks, and in particular, to a method and device of implementing compatibility with wired earphones.

### BACKGROUND OF THE INVENTION

At present, most terminal devices, such as computers, mobile phones, MP3, MP4, and PSPs, provide earphone jacks for insertion of earphones so that audio files stored in the terminal devices may be played through the earphones.

During the implementation of the present invention, the inventor discovers that, although the structure and size of earphone plugs are the same, there are two interface standards for earphones while the above terminal devices generally support earphones of only one standard. FIG. 1 is a schematic structural diagram of an earphone plug in the prior art. With regard to an earphone of one standard, the plug tip contactor contacts the left channel, the plug middle ring 1 contactor contacts the right channel, the plug middle ring 2 contactor contacts a microphone, and the plug base contactor contacts a signal loop; and with regard to an earphone of the other standard, the plug tip contactor contacts the left channel, the plug middle ring 1 contactor contacts the right channel, the plug middle ring 2 contactor contacts a signal loop, and the plug base contactor contacts a microphone. FIG. 2 is a schematic diagram of the wiring of an earphone jack of a terminal device in the prior art, where 1 contacts the left channel, 2 contacts the right channel, 3 contacts the microphone or signal loop, 4 contact the signal loop or microphone, and 5 contacts the shell. According to FIG. 1 and FIG. 2, where the definition of the earphone jack of the terminal device is inconsistent with the definition of the earphone plug, namely, the microphone (MIC) of the earphone plug is connected to the signal loop (GND) of the terminal device and the signal loop (GND) of the earphone plug is connected to the microphone signal (MIC) of the terminal device, which may cause the following two results:

1. The sounds heard from the left and right speakers of the earphone are low and distorted.

2. The microphone of the earphone does not work.

### SUMMARY OF THE INVENTION

Embodiments of the present invention provide a method and device of implementing compatibility with wired earphones to solve the problem that a terminal device is not compatible with earphones of two different standards.

In one aspect, an embodiment of the present invention provides a method of implementing compatibility with wired earphones, where the method includes:
judging the type of an earphone plug; and
controlling, according to the type of the earphone plug, a circuit switch to conduct a circuit path corresponding to the type of the earphone plug.

In another aspect, an embodiment of the present invention further provides a device of implementing compatibility with wired earphones, where the device includes:
a judging unit, configured to judge the type of an earphone plug;
a connectivity unit, configured to control, according to the type of the earphone plug, a circuit switch to conduct a circuit path corresponding to the type of the earphone plug; and
the circuit switch, configured to conduct the circuit path corresponding to the type of the earphone plug according to the control of the connectivity unit.

In still another aspect, an embodiment of the present invention further provides a terminal device, where the terminal device includes the above device of implementing compatibility with wired earphones.

With the method and device provided by the embodiments of the present invention, a terminal device is compatible with earphones of two different standards.

### BRIEF DESCRIPTION OF THE DRAWINGS

The accompanying drawings here are provided to help understand the present invention and constitute a part of this application, but do not limit the present invention. In the drawings:

FIG. 1 is a schematic structural diagram of an earphone plug in the prior art;

FIG. 2 is a schematic wiring diagram of an earphone jack of a terminal device in the prior art;

FIG. 3 is a flowchart of a method according to an embodiment of the present invention;

FIG. 4 is a flowchart of an embodiment of a method for judging the type of an earphone plug according to the embodiment of the present invention;

FIG. 5 is a flowchart of another embodiment of a method for judging the type of an earphone plug according to the embodiment of the present invention;

FIG. 6A and FIG. 6B are a structural diagram of a device according to an embodiment of the present invention;

FIG. 7 is a circuit diagram of an earphone jack circuit of a terminal device;

FIG, 8 is a circuit diagram of earphone jack pins of a terminal device;

FIG. 9 is a circuit diagram of a comparison circuit of a terminal device;

FIG. 10 is a circuit diagram of a switching circuit of a terminal device; and

FIG. 11 is a structural diagram of a terminal device according to an embodiment of the present invention.

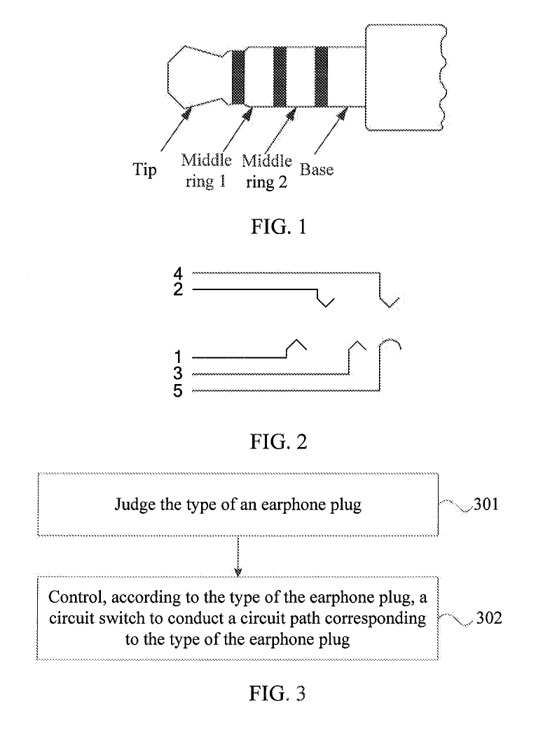

### DETAILED DESCRIPTION OF THE EMBODIMENTS

To better explain the purpose, technical solution, and advantages of the present invention, the embodiments of the present invention are described in detail with reference to the accompanying drawings. The exemplary embodiments and the descriptions of the present invention are intended to explain the present invention and should not be construed as limitations on the present invention.

FIG. 3 is a flowchart of a method of implementing compatibility with wired earphones according to an embodiment of the present invention. The method is applicable to a terminal device with an earphone jack. As shown in FIG. 3, the method includes the following steps:

301: Judge the type of an earphone plug.

In the embodiment, the type of an earphone plug is the interface standard of the earphone plug. As described in the background of the present invention, there are two interface standards at present. The embodiment, however, is not limited to such standards, With the development of technologies, the method of the embodiment is also applicable to multiple types of earphone plugs.

In the embodiment, the earphone plug is inserted to the earphone jack of the terminal device. The terminal device judges the type of the earphone plug inserted to its earphone jack. In the embodiment, there are many methods of judging the type of an earphone plug and the methods are described in other embodiments of the present invention, but the embodiment is not limited to such methods.

302: Control, according to the type of the earphone plug, a circuit switch to conduct the circuit path corresponding to the type of the earphone plug.

In the embodiment, where the type (interface standard) of earphone plugs varies, the circuit path of the terminal device corresponding to each contactor of the earphone plug is different. For an earphone plug with a tip contactor contacting the left channel, middle ring 1 contactor contacting the right channel, middle ring 2 contactor contacting the microphone, and base contactor contacting the signal loop, according to the method of the embodiment, the L/R/M/GND path of the terminal device needs to be conducted. For an earphone plug with a tip contactor contacting the left channel, middle ring 1 contactor contacting the right channel, middle ring 2 contactor contacting the signal loop, and base contactor contacting the microphone, according to the method of the embodiment, the L/R/GND/M path of the terminal device needs to be conducted.

In the embodiment, different methods are used to conduct the circuit path corresponding to the type of the earphone plug according to the different methods used to judge the type of the earphone plug, which are also described in other embodiments of the present invention.

With the method of the embodiment, the terminal device is compatible with earphones of different standards, which avoids such problems as low and distorted sounds heard from the left and right speakers of earphones and the failure of the earphone microphone caused by different earphone standards.

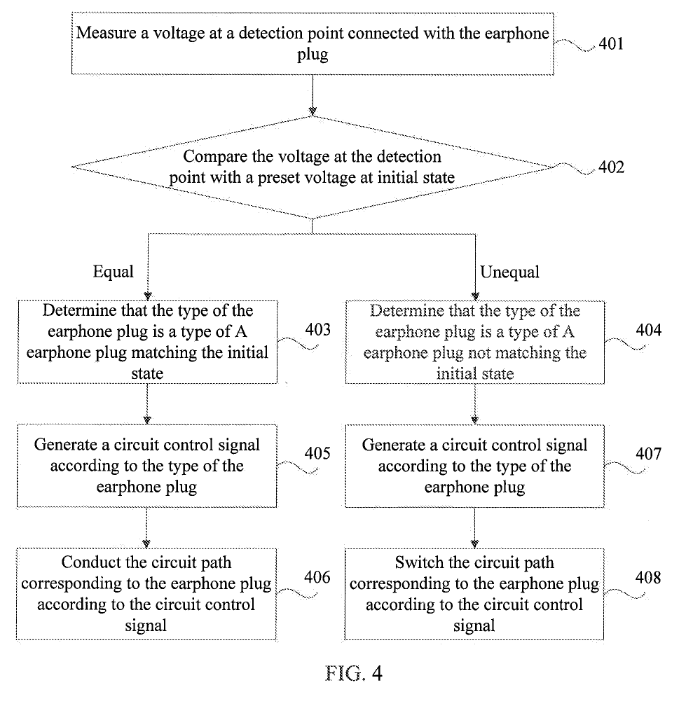

FIG. 4 is a flowchart of one embodiment of judging the type of an earphone plug in the method of implementing compatibility with wired earphones according to the embodiment of the present invention. As shown in FIG. 4, the method includes:

401: Measure a voltage at a detection point connected with the earphone plug.

402: Compare the voltage at the detection point with a preset voltage at initial the state.

403: If the voltage at the detection point equals the preset voltage at the initial state, determine that the type of the earphone plug is a type of an earphone plug matching the initial state.

404: If the voltage at the detection point is unequal to the preset voltage at the initial state, determine that the type of the earphone plug is a type of an earphone plug not matching the initial state.

In the embodiment, if the voltage at the detection point equals the preset voltage at the initial state, controlling, according to the type of the earphone plug, a circuit switch to conduct the circuit path corresponding to the earphone plug may include the following steps:

405: Generate a circuit control signal according to the type of the earphone plug.

406: Conduct the circuit path corresponding to the earphone plug according to the circuit control signal.

In the embodiment, if the voltage at the detection point is unequal to the preset voltage at the initial state, the controlling, according to the type of the earphone plug, the circuit switch to conduct the circuit path corresponding to the earphone plug may include the following steps:

407: Generate a circuit control signal according to the type of the earphone plug.

408: Switch the circuit path of the earphone plug according to the circuit control signal.

In the embodiment, a voltage at the initial state may be preset and a corresponding circuit path is set for one type of earphone plug according to the voltage at the initial state. According to the method of the embodiment, when it is detected that the voltage measured at the detection point equals the preset voltage at the initial state, the earphone plug inserted to a earphone jack is the same as the type of earphone plug corresponding to the preset voltage at the initial state. In this case, a preset state value may be defined for the circuit switch and the circuit path of the earphone plug corresponding to the type of earphone plug matching the voltage at the initial state may be directly conducted through the circuit switch. According to the method of the embodiment, when it is detected that the voltage measured at the detection point is unequal to the preset voltage at the initial state, that is, when the voltage at the detection point has changed relative to the preset voltage at the initial state, it indicates that the earphone plug inserted to the earphone jack is different from the type of earphone plug corresponding to the preset voltage at the initial state. In this case, another state value may be defined for the circuit switch, for example, a value which enables the circuit switch to be overturned, and the circuit path of the earphone plug corresponding to the type of earphone plug matching the initial state is switched through the circuit switch.

In the embodiment, the circuit switch may be a single pole double throw switch but the embodiment is not limited thereto. The circuit switch controls the circuit path of the earphone plug to be L/R/M/GND or L/R/GND/M according to detected state, namely a received circuit control signal.

According to the method of the embodiment, the terminal device is compatible with earphone plugs of two different standards, thus avoiding the problems in use of earphones caused by different circuit paths matching different standards.

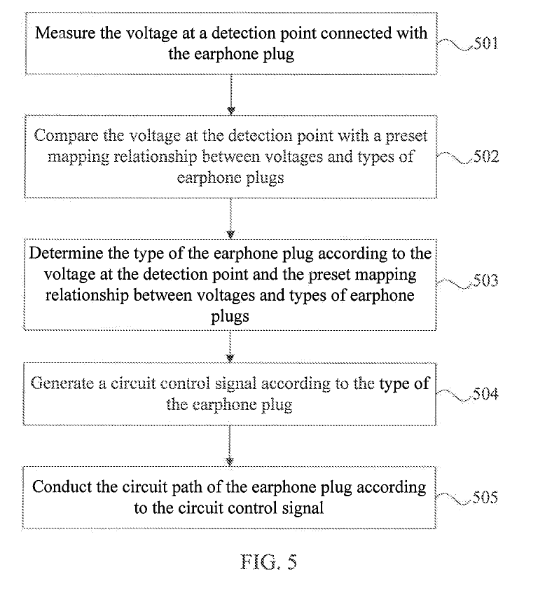

FIG. 5 is a flowchart of another embodiment of judging the type of an earphone plug in the method of implementing compatibility with wired earphones according to the embodiment of the present invention. As shown in FIG. 5, the method includes:

501: Measure the voltage value at a detection point connected with the earphone plug.

502: Compare the voltage at the detection point with a preset voltage which is mapped to the type of earphone plug.

503: Determine the type of the earphone plug according to the voltage at the detection point and the preset mapping relationship between voltages and types of earphone plugs.

In the embodiment, after the type of the earphone plug is determined according to the above method, the controlling, according to the type of the earphone plug, the circuit switch to conduct the circuit path corresponding to the type of the earphone plug may include the following:

504: Generate a circuit control signal according to the type of the earphone plug.

505: Conduct the circuit path of the earphone plug according to the circuit control signal:

In the embodiment, a mapping relationship between voltages and types of earphone plugs may be preset and the type of the earphone plug is determined according to a measured voltage. The voltage here may be a voltage range. For example, range 1 is defined to match earphones of a first standard, range 2 is defined to match earphones of a second standard, and range 3 is defined to match earphones of a third standard. When the measured voltage falls within range 2, it is determined that the earphone is of the second standard.

In the embodiment, earphones of each standard match one circuit path. According to the method of the embodiment, after the type of the earphone plug is determined, a circuit control signal may be generated accordingly. For example, earphones of the first standard match path A, earphones of the second standard match path B, and earphones of the third standard match path C. Then, according to the foregoing measurement and comparison, the earphone is of the second standard and, according to the method of the embodiment, the generated circuit control signal indicates switching to path B.

In the embodiment, after the above circuit control signal is obtained, the circuit switch conducts a corresponding circuit path, for example, path B in the foregoing example.

According to the method of the embodiment, the terminal device is compatible with earphone plugs of two or more different standards, thus avoiding the problems in use of earphones caused by different circuit paths matching different standards.

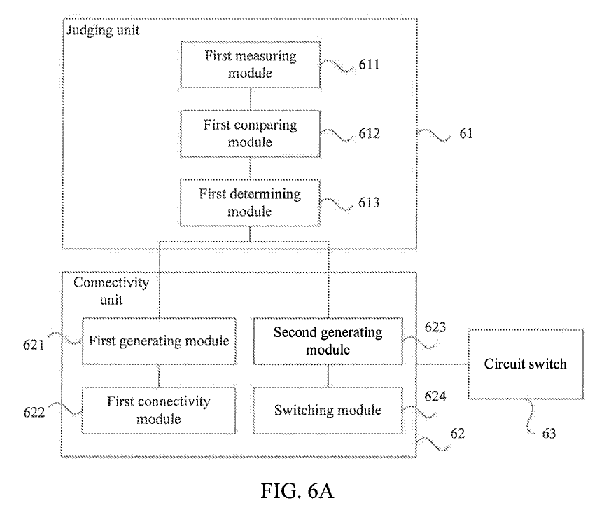

FIG. 6A and FIG. 6B are a structural diagram of a device of implementing compatibility with wired earphones according to an embodiment of the present invention. The device is applicable to a terminal device that has an earphone jack. As shown in FIG. 6A and FIG. 6B, the device includes:
a judging unit 61, configured to judge the type of an earphone plug;
a connectivity unit 62, configured to control a circuit switch 63 to conduct a circuit path corresponding to the type of the earphone plug according to the type of the earphone plug; and
a circuit switch 63, configured to conduct the circuit path corresponding to the type of the earphone plug according to the control of the connectivity unit 62.

According to one implementation of the embodiment, as shown in FIG. 6A, the judging unit 61 may include:
a first measuring module 611, configured to measure the voltage at a detection point connected with the earphone plug;
a first comparing module 612, configured to compare the voltage at the detection point with a preset voltage at the initial state; and
a first determining module 613, configured to determine that the type of the earphone plug is the type of an earphone plug matching the initial state when the comparison result of the first comparing module 612 is that the voltage at the detection point equals the preset voltage at the initial state.

According to the implementation, the connectivity unit 62 may include:
a first generating module 621, configured to generate a circuit control signal according to the type of the earphone plug; and
a first connectivity module 622, configured to conduct the circuit path of the earphone plug according to the circuit control signal.

In the embodiment, the first determining module 613 is further configured to determine that the type of the earphone plug is a type of an earphone plug not matching the initial state when the comparison result of the first comparing module 612 is that the voltage at the detection point is unequal to the preset voltage at the initial state.

According to this implementation, the connectivity unit 62 may include:
a second generating module 623, configured to generate a circuit control signal according to the type of the earphone plug; and
a switching module 624, configured to switch the circuit path of the earphone plug according to the circuit control signal.

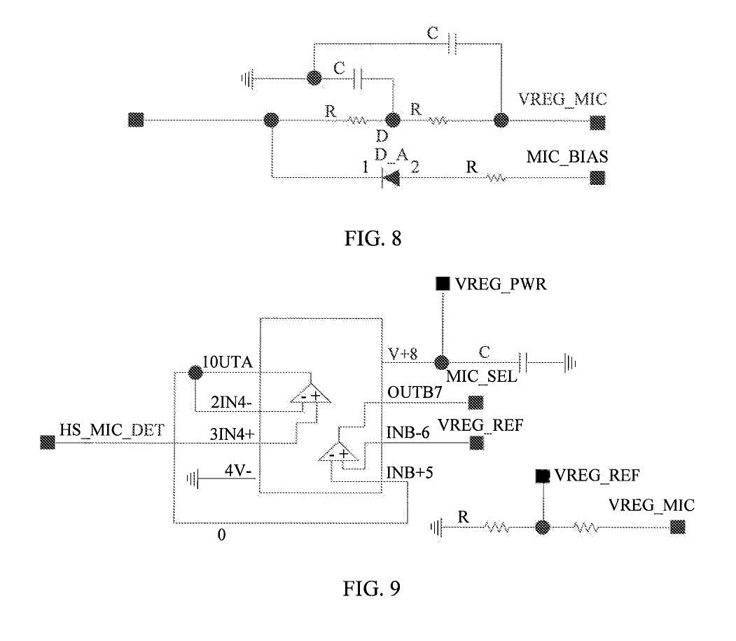

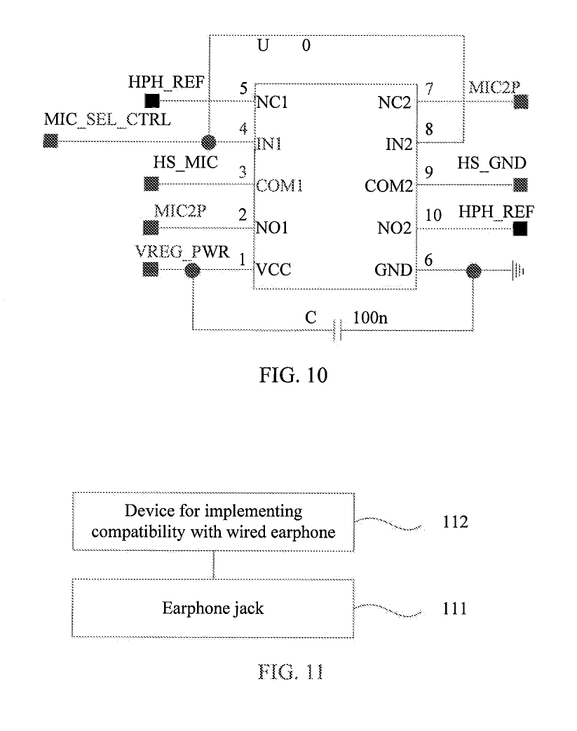

The first measuring module 611 may be implemented through the electric circuit shown in FIG. 8; the first comparing module 612 may be composed of an operational amplifier and a comparer, for example, implemented through the circuit shown in FIG. 9; the circuit switch 63 may be a single pole double throw switch, for example, implemented through the circuit shown in FIG. 10. The embodiment, however, is not limited to such implementations. The measurement, comparison, and the circuit switch function may also be implemented, for example, through software.

The first generating module 621 and the second generating module 623 may be implemented through one module and the first connectivity module 622 and the switching module 624 may be implemented through one module, but the embodiment is not limited to such implementations.

According to another implementation of the embodiment, as shown in FIG, 6B, the judging unit 61 may include:
a second measuring module 614, configured to measure the voltage at a detection point connected with the earphone plug;
a second comparing module 615, configured to compare the voltage at the detection point with a preset voltage which is mapped to the type of earphone plug; and
a second determining module 616, configured to determine the type of the earphone plug according to the comparison result of the second comparing module 615.

According to this implementation, the connectivity unit 62 may include:
a third generating module 625, configured to generate a circuit control signal according to the type of the earphone plug; and
a second connectivity module 626, configured to conduct the circuit path of the earphone plug according to the circuit control signal.

Each component of the device in the embodiment is respectively used to implement each step of the method in the foregoing embodiments. Because the steps are already described in detail in the method embodiments, the steps are not described here.

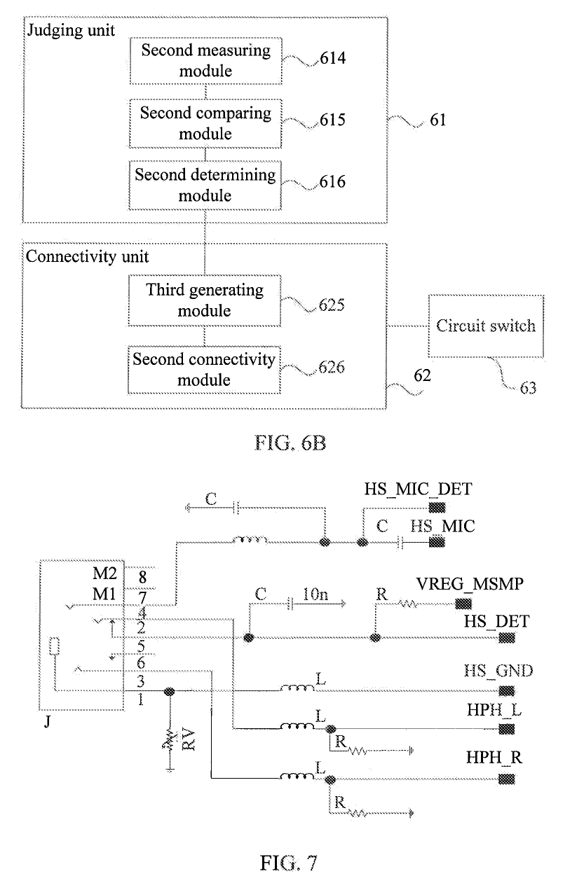

FIG. 7 to FIG. 10 are the implementations of the device of implementing compatibility with wired earphones according to the embodiment through circuits and are described respectively.

FIG. 7 is a circuit diagram of the earphone jack circuit of the terminal device. As shown in FIG. 7, the earphone plug is inserted to the J end to connect the earphone jack; C is a capacitor, L is an inductor, R is a resistor, and RV is a variable resistor, and the same symbol has the same meaning in the following circuit diagrams and is not repeated; HS_MIC_DET is used to provide the voltage at the detection point; HS_MIC is used to contact a microphone; VREG_MISMP is used to connect a reference voltage; HS_DET is used for earphone insertion detection; HS_GND is used to contact the ground; HPH_L is used to contact the left channel of the terminal device; HPH_R is used to contact the right channel of the terminal device.

FIG. 8 is a circuit diagram of earphone jack pins. As shown in FIG. 8, HS_MIC_DET contacts the HS_MIC_DET in FIG. 7 and is used to obtain the voltage at the detection point; VREG_MIC and MIC_BIAS each connect the reference voltage.

FIG. 9 is a circuit diagram of a comparison circuit. As shown in FIG. 9, HS_MIC_DET contacts the HS_MIC_DET in FIG. 7 and is used to obtain the voltage at the detection point; VREG_PWR connects a power supply; MIC_SEL is the output of the comparison circuit and connects the control chip of the terminal device; and VREG_REF connects the reference voltage.

FIG. 10 is a circuit diagram of a switching circuit. As shown in FIG. 10, pin 1 is used to connect the power supply; pin 2 and pin 7 are used to connect the MIC signal of the terminal device; pin 3 is used to connect the MIC end of the earphone jack, such as HS_MIC shown in FIG, 7; pin 4 is used to connect the control chip of the terminal device to receive the control signal; pin 5 and pin 10 are used to connect the return signal of a baseband chip mic; pin 6 contacts the ground; pin 4 and pin 8 connect a switch control signal; and pin 9 is used to connect the loop of the earphones.

The above is a hardware implementation of the device of implementing compatibility with wired earphones and the embodiment is not limited to the implementation. The embodiment may also be implemented, for example, through software or other circuits, provided that the functions of each component of the device of implementing compatibility with wired earphones in the embodiment are fulfilled, and all such implementations fall within the scope of the embodiments of the present invention.

According to the device in the embodiment, the terminal device is compatible with earphone plugs of two or more different standards, thus avoiding the problems in use of earphones caused by different circuit paths matching different standards.

FIG. 11 is a structural diagram of a terminal device according to an embodiment of the present invention. As shown in FIG. 11, in addition to the functional components of the terminal device, the terminal device further includes an earphone jack 111 and a device 112 of implementing compatibility with wired earphones, where the device 112 of implementing compatibility with wired earphones may be the device of implementing compatibility with wired earphones in the embodiment shown in FIG. 6 and is not further described here.

In the embodiment, the terminal may be a computer, mobile phone, MP3, MP4, or PSP.

The terminal device provided in the embodiment is compatible with earphone plugs of two or more different standards, thus avoiding the problems in use of earphones caused by different circuit paths matching different standards.

The steps of the method or algorithm described in the embodiments disclosed here may be implemented directly through hardware, or a software module executed by a processor, or a combination of both. The software module may be disposed in a random access memory (RAM), a memory, a read-only memory (ROM), an electric programmable ROM, an electric erasable and programmable ROM, a register, a hard disk, a removable disk, a CD-ROM, or any other form of storage medium commonly known in the art.

The purpose, technical solution, and benefits of the present invention have been described in detail through some exemplary embodiments. It is understandable that the foregoing embodiments are exemplary and not intended to limit the protection scope of the invention, Any modifications, substitutions, and improvements made to the invention without departing from the spirit and principle of the invention shall be included in the protection scope of the invention.

What is claimed is:

1. A method of implementing compatibility with wired earphones, comprising:
judging the type of an earphone plug; and
controlling, according to the type of the earphone plug, a circuit switch to conduct a circuit path corresponding to the type of the earphone plug.

2. The method according to claim 1, wherein the judging the type of the earphone plug comprises:
measuring a voltage at a detection point connected with the earphone plug; and
if the voltage at the detection point equals a preset voltage at the initial state, determining that the type of the earphone plug is a type of a earphone plug matching the initial state,

3. The method according to claim 2, wherein the controlling, according to the type of the earphone plug, the circuit switch to conduct the circuit path corresponding to the type of the earphone plug comprises:
generating a circuit control signal according to the type of the earphone plug; and
closing the circuit path of the earphone plug according to the circuit control signal,

4. The method according to claim 2, wherein the judging the type of the earphone plug further comprises:
if the voltage at the detection point is unequal to the preset voltage at the initial state, determining that the type of the earphone is a type of a earphone plug not matching the initial state.

5. The method according to claim 4, wherein the controlling, according to the type of the earphone plug, the circuit switch to close the circuit path corresponding to the type of the earphone plug comprises:
generating a circuit control signal according to the type of the earphone plug; and
switching the circuit path of the earphone plug according to the circuit control signal.

6. The method according to claim 1, wherein the judging the type of the earphone plug comprises:
measuring a voltage at a detection point connected with the earphone plug; and
determining the type of the earphone plug according to the detection point voltage and a preset mapping relationship between voltages and types of earphone plugs.

7. The method according to claim 6, wherein the controlling, according to the type of the earphone plug, the circuit switch to conduct the circuit path corresponding to the type of the earphone plug comprises:
generating a circuit control signal according to the type of the earphone plug; and
conducting the circuit path of the earphone plug according to the circuit control signal.

8. A device of implementing compatibility with wired earphones, comprising:
a judging unit, configured to judge the type of an earphone plug;
a connectivity unit, configured to control, according to the type of the earphone plug, a circuit switch to conduct a circuit path corresponding to the type of the earphone plug; and
the circuit switch, configured to conduct the circuit path corresponding to the type of the earphone plug according to the control of the connectivity unit.

9. The device according to claim 8, wherein the judging unit comprises:
a measuring module, configured to measure a voltage at a detection point connected with the earphone plug;
a comparing module, configured to compare the voltage at the detection point and a preset voltage at the initial state; and
a determining module, configured to determine that the type of the earphone plug is a type of a earphone plug matching the initial state when a comparison result of the comparing module is that the voltage at detection point equals the preset voltage at the initial state.

10. The device according to claim 9, wherein the connectivity unit comprises:
a generating module, configured to generate a circuit control signal according to the type of the earphone plug; and
a connectivity module, configured to conduct the circuit path of the earphone plug according to the circuit control signal.

11. The device according to claim 9, wherein:
the determining module is further configured to determine that the type of the earphone plug is a type of a earphone plug not matching the initial state when the comparison result of the comparing module is that the voltage at the detection point is unequal to the preset voltage at the initial state.

12. The device according to claim 11, wherein the connectivity unit comprises:
a generating module, configured to generate a circuit control signal according to the type of the earphone plug; and
a switching module, configured to switch the circuit path of the earphone plug according to the circuit control signal.

13. The device according to claim 8, wherein the judging unit comprises:
a measuring module, configured to measure a voltage at a detection point connected with the earphone plug;
a comparing module, configured to Compare the voltage at the detection point with a preset voltage which is mapped to the type of earphone plug; and
a determining module, configured to determine the type of the earphone plug according to a comparison result of the comparing module.

14. The device according to claim 13, wherein the connectivity unit comprises:
a generating module, configured to generate a circuit control signal according to the type of the earphone plug; and
a connectivity module, configured to conduct the circuit path of the earphone plug according to the circuit control signal.

15. A terminal device, comprising a wired earphone jack, a device of implementing compatibility with wired earphones, and at least two circuit paths corresponding to different types of earphone plug respectively, the device of implementing compatibility with wired earphones comprising:
a judging unit, configured to judge the type of an earphone plug;
a connectivity unit, configured to control, according to the type of the earphone plug, a circuit switch to conduct a circuit path corresponding to the type of the earphone plug; and
the circuit switch, configured to conduct the circuit path corresponding to the type of the earphone plug according to the control of the connectivity unit.

16. The terminal device according to claim 15, wherein the judging unit comprises:
a measuring module, configured to measure a voltage at a detection point connected with the earphone plug;
a comparing module, configured to compare the voltage at the detection point and a preset voltage at the initial state; and
a determining module, configured to determine that the type of the earphone plug is a type of a earphone plug matching the initial state when a comparison result of the comparing module is that the voltage at detection point equals the preset voltage at the initial state:

17. The terminal device according to claim 16, wherein the connectivity unit comprises:
a generating module, configured to generate a circuit control signal according to the type of the earphone plug; and
a connectivity module, configured to conduct the circuit path of the earphone plug according to the circuit control signal.

18. The terminal device according to claim 16, wherein:
the determining module is further configured to determine that the type of the earphone plug is a type of a earphone plug not matching the initial state when the comparison result of the comparing module is that the voltage at the detection point is unequal to the preset voltage at the initial state;
the connectivity unit comprises:
a generating module, configured to generate a circuit control signal according to the type of the earphone plug; and
a switching module, configured to switch the circuit path of the earphone plug according to the circuit control signal.

19. The device according to claim 15, wherein the judging unit comprises:
a measuring module, configured to measure a voltage at a detection point connected with the earphone plug;
a comparing module, configured to Compare the voltage at he detection point with a preset voltage which is mapped to the type of earphone plug; and
a determining module, configured to determine the type of the earphone plug according to a comparison result of the comparing module.

20. The device according to claim 19, wherein the connectivity unit comprises:
a generating module, configured to generate a circuit control signal according to the type of the earphone plug; and
a connectivity module, configured to conduct the circuit path of the earphone plug according to the circuit control signal.
